(19) United States
(12) Patent Application Publication
(10) Pub. No.: US 2013/0267331 A1
(43) Pub. Date: Oct. 10, 2013

(54) LUBRICATION MANAGEMENT SYSTEM FOR A ROTATING SHAFT ASSEMBLY AND METHOD OF FORMING

(71) Applicants: William C. Trommer, Byron, IL (US); Michael R. Blewett, Stillman Valley, IL (US); Matthew Slayter, Rockford, IL (US)

(72) Inventors: William C. Trommer, Byron, IL (US); Michael R. Blewett, Stillman Valley, IL (US); Matthew Slayter, Rockford, IL (US)

(73) Assignee: HAMILTON SUNDSTRAND CORPORATION, Windsor Locks, CT (US)

(21) Appl. No.: 13/441,174

(22) Filed: Apr. 6, 2012

(51) Int. Cl. F01M 11/00; F16N 1/00; B23P 11/00; F16C 3/02

(52) U.S. Cl. 464/7; 29/456

(57) ABSTRACT

A lubrication management system for a rotating shaft assembly includes a shaft rotatable about a central axis and in operable connection with at least one component, wherein lubrication is supplied proximate an outer diameter of the shaft. Also included is a lubrication manipulation device for directing the lubrication radially away from the outer diameter of the shaft, wherein the lubrication manipulation device comprises a threaded portion for fixedly securing the lubrication manipulation device to the outer diameter of the shaft.

### BACKGROUND OF THE INVENTION

The present invention relates to rotating shaft assemblies, and more particularly to a lubrication management system for such shaft assemblies, as well as a method for forming the lubrication management system.

Various systems comprising rotating components often include a shaft to which the rotating components are mounted or operably connected to. The shaft typically requires lubrication proximate an outer surface to ensure intended functionality of the overall system. Often, a shaft seal is not feasible and even in configurations where feasible, such seals have an inherently slight weepage. Therefore, lubrication outside of the intended contained area occurs and may undesirably interact with components of the system that function properly when kept clean of lubrication. In order to keep the components free of lubrication, a slinger is commonly installed on the shaft to centrifugally move the lubricant away from the shaft. The slinger must be retained and this is typically achieved with a separate and additional locking component. Multiple components pose installation issues and increase part count, as well as enhance the footprint on the shaft.

### BRIEF DESCRIPTION OF THE INVENTION

According to one embodiment, a lubrication management system for a rotating shaft assembly includes a shaft rotatable about a central axis and in operable connection with at least one component, wherein lubrication is supplied proximate an outer diameter of the shaft. Also included is a lubrication manipulation device for directing the lubrication radially away from the outer diameter of the shaft, wherein the lubrication manipulation device comprises a threaded portion for fixedly securing the lubrication manipulation device to the outer diameter of the shaft.

According to another embodiment, a method of forming a lubrication management system for a rotating shaft assembly is provided. The method includes operably connecting at least one component to a shaft rotatable about a central axis. Also included is fixedly securing a lubrication manipulation device to the shaft by threading the lubrication manipulation device onto an outer diameter of the shaft, wherein the lubrication manipulation device is configured to direct lubrication supplied to the outer diameter of the shaft radially away from the shaft.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a side, cross-sectional view of a rotating shaft assembly having a lubrication management system;

FIG. 2 is a perspective view of a lubrication manipulation device of the lubrication management system;

FIG. 3 is a plan view of the lubrication manipulation device of the lubrication management system;

FIG. 4 is a cross-sectional view of the lubrication manipulation device taken along line IV-IV of FIG. 3; and

FIG. 5 is a flow diagram illustrating a method of forming the lubrication management system.

### DETAILED DESCRIPTION OF THE INVENTION

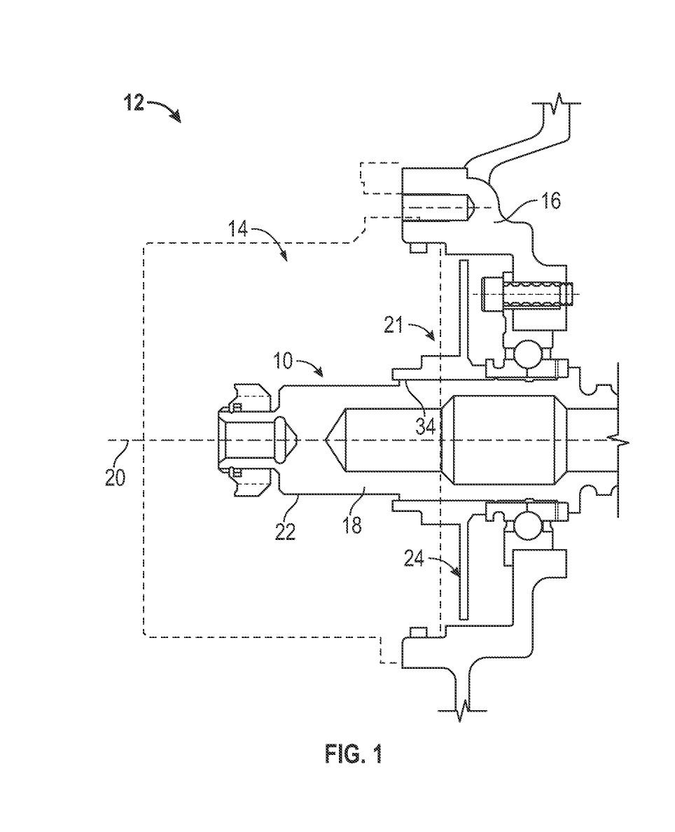

Referring to FIG. 1, a rotating shaft assembly is generally represented with reference numeral 10 and is disposed within a system 12 that requires at least one component 14 that rotates within a system housing 16. The system 12 may be of various types, such as an electrical, mechanical, or electromechanical system. The at least one component 14 may include a variety of components typically disposed within an application, such as the system 12 described above. Specifically, the at least one component 14 includes, but is not limited to, permanent magnet alternators (PMAs), brakes, and clutches, for example. These examples are merely illustrative and is not an exhaustive list of components that the at least one component 14 comprises. Irrespective of the particular component, it is often desirable to prevent lubrication or fluid from contacting or interacting with the at least one component 14.

The rotating shaft assembly 10 includes a shaft 18 that is rotatable about a central axis 20 and is in operable connection with, or in close proximity to, the at least one component 14. To enhance functionality, efficiency and service life of the system 12, a lubrication management system 21 having lubrication is supplied to various regions of the rotating shaft assembly 10, such as an outer diameter 22 of the shaft 18. The lubrication may be supplied from a lubrication supply circuit (not illustrated) that provides lubrication to the rotating shaft assembly 10, collects lubrication subsequent to interaction with the rotating shaft assembly 10 and recirculates the collected lubrication to provide lubrication once again to the rotating shaft assembly 10, thereby completing a lubrication recirculation process.

To prevent interaction of lubrication with the at least one component 14, a lubrication manipulation device 24, commonly referred to as a “slinger,” is fixedly secured to the shaft 18. The lubrication manipulation device 24 is disposed radially outward from the shaft 18 and in fitting engagement with the outer diameter 22 of the shaft 18. The lubrication manipulation device 24 functions to direct lubricant from regions proximate the outer diameter 22 of the shaft 18 radially outward and away from the shaft 18, such that the lubrication does not seep or flow to the at least one component 14 that is sensitive to lubricant, as discussed above. Specifically, as the shaft 18 is rotating, the lubrication manipulation device 24 is configured to rotate in a way that generates a centrifugal force sufficient to throw the lubrication radially outward through a plurality of capillaries (not illustrated) of the lubrication manipulation device 24. It is to be appreciated that the lubrication merely need be directed outward and away from the rotating shaft assembly 10, and the term radially is not intended to limit the direction of lubricant throwing to that of a 90° angle (i.e., perfectly perpendicular) from the rotating shaft assembly 10, and more particularly from the shaft 18.

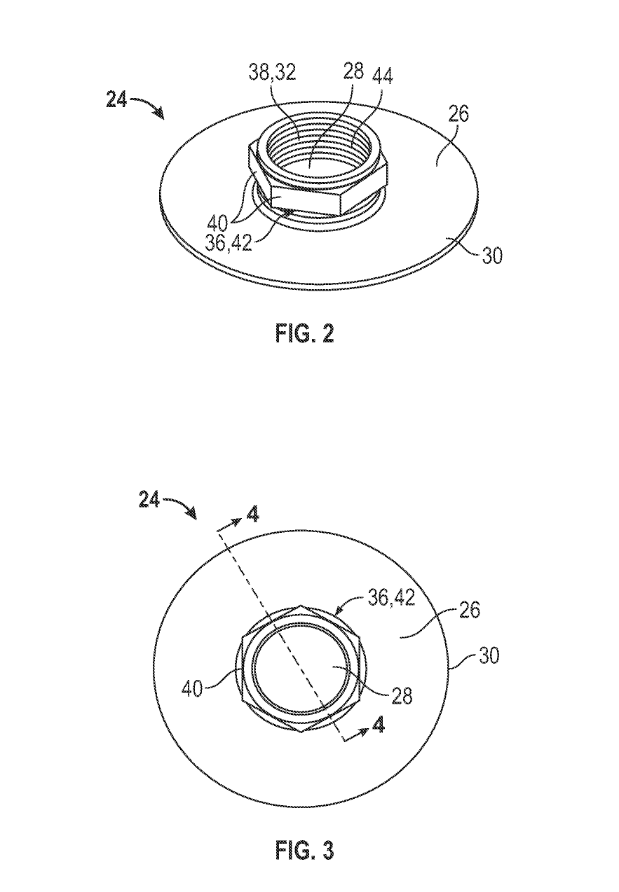

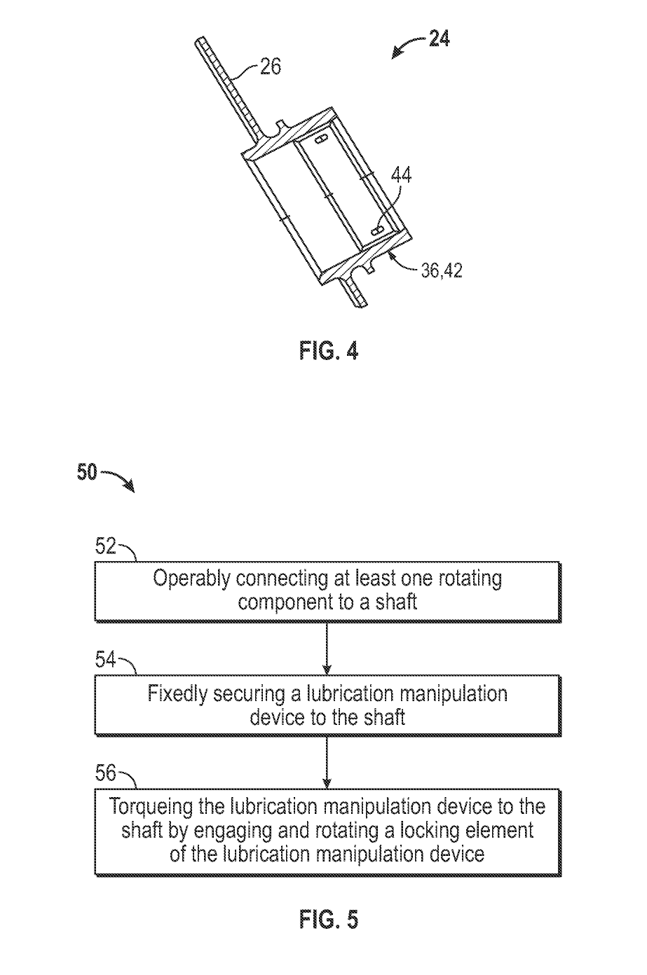

Referring now to FIGS. 2-4, the lubrication manipulation device 24 is illustrated in greater detail. As described above, the lubrication manipulation device 24 is fixedly secured to the outer diameter 22 of the shaft 18. In an exemplary embodiment, the lubrication manipulation device 24 includes a relatively planar base portion 26 that is illustrated as having a cylindrical geometry, however, it is contemplated that other geometric configurations may be employed to achieve the intended function. The relatively planar base portion 26 extends radially outward from a centrally located aperture 28 that is dimensioned to closely engage the outer diameter 22 of the shaft 18 to an outer surface 30. Lubricant is directed radially outward in response to centrifugal forces generated during rotation of the lubrication manipulation device 24. Specifically, the lubricant moves radially outward along a smooth plane of the lubrication manipulation device 24 due to the centrifugal forces exerted on the lubricant. Along the centrally located aperture 28 is a threaded portion 32 that is configured to engage a threaded region 34 (FIG. 1) of the outer diameter 22 of the shaft 18. Upon engagement with the shaft 18, the relatively planar base portion 26 of the lubrication manipulation device 24 is oriented in an axial plane along the shaft 18.

Extending axially from the relatively planar base portion 26 is a torque element 36 that is integrally formed with the relatively planar base portion 26, such that the lubrication manipulation device 24 comprises a single device configured to direct lubrication away from the shaft 18. The torque element 36 extends axially from the relatively planar base portion 26 and includes a threaded aperture 38 that is aligned with the centrally located aperture 28, such that the lubrication manipulation device 24 may be securely engaged with the shaft 18 by threading to the threaded region 34. Such an arrangement ensures adequate retention in the axial direction, as well as radially and circumferentially. To enhance the fixed securement of the lubrication manipulation device 24 to the shaft 18, the torque element 36 includes a plurality of surfaces 40 that form a nut 42 which may be engaged with a variety of tools to assist with a final torque application to the lubrication manipulation device 24.

During the secure engagement of the lubrication manipulation device 24 to the shaft 18, a locking element 44 self-retains the lubrication manipulation device 24 to the shaft 18 for adequate locking thereon. The locking element 44 is integrally formed with the lubrication manipulation device 24 and is configured to interact with the threaded relationship between the threaded portion 32 and the threaded region 34 during torqueing of the lubrication manipulation device 24 to the shaft 18. The locking element 44 may comprise a lock ring, a locking pellet, a deformed thread, etc., for example. It is to be appreciated that the examples listed above are merely illustrative and any suitable locking element may be employed to form adequate locking with the shaft 18.

Referring now to FIG. 5, a method of forming 50 the lubrication management system 21 is also provided. The lubrication management system 21, as well as the rotating shaft assembly 10, have been previously described and specific structural components need not be described in further detail. The method of forming 50 includes operably connecting 52 the at least one component 14 to the shaft 18 and fixedly securing 54 the lubrication manipulation device 24 to the shaft 18. The lubrication manipulation device 24 may be fixedly secured to the shaft 18, and more specifically the outer diameter 22 of the shaft 18, by threading onto the threaded region 34 of the shaft 18. To ensure adequate locking and a fixed securement of the lubrication manipulation device 24 to the shaft 18, the method of forming 50 further includes torqueing 56 the lubrication manipulation device 24 by engaging and rotating the torque element 36. Additionally, the locking element 44 ensures retention of the lubrication manipulation device 24 to the shaft and prevents displacement of the lubrication manipulation device 24 in all directions, namely axial, radial, and circumferential, with respect to the central axis 20 of the system 12.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A lubrication management system for a rotating shaft assembly comprising:
a shaft rotatable about a central axis and in operable connection with at least one component, wherein lubrication is supplied proximate an outer diameter of the shaft;
a lubrication manipulation device for directing lubrication radially away from the outer diameter of the shaft, wherein the lubrication manipulation device comprises a threaded portion for fixedly securing the lubrication manipulation device to the outer diameter of the shaft; and
a locking element integrally formed with the lubrication manipulation device, wherein the locking element is disposed proximate the threaded portion of the lubrication manipulation device.

2. The lubrication management system of claim 1, wherein the lubrication manipulation device comprises a relatively planar base oriented in an axial plane along the shaft.

3. The lubrication management system of claim 2, wherein the lubrication manipulation device comprises a centrally located aperture dimensioned to closely engage the outer diameter of the shaft.

4. The lubrication management system of claim 3, wherein the threaded portion of the lubrication manipulation device is disposed proximate the centrally located aperture.

5. The lubrication management system of claim 2, wherein the relatively planar base is cylindrical.

6. The lubrication management system of claim 3, further comprising a torque element integrally formed with the lubrication manipulation device, wherein the torque element extends axially from the relatively planar base.

7. The lubrication management system of claim 6, wherein the torque element comprises a threaded aperture aligned with the centrally located aperture of the lubrication manipulation device.

8. The lubrication management system of claim 7, wherein the torque element further comprises a plurality of surfaces forming a nut for torqueing of the lubrication manipulation device to the shaft.

9. The lubrication management system of claim 1, wherein the at least one component comprises at least one of a permanent magnet alternator, a clutch and a brake.

10. (canceled)

11. A method of forming a lubrication management system for a rotating shaft assembly comprising:
operably connecting at least one component to a shaft rotatable about a central axis;
fixedly securing a lubrication manipulation device to the shaft by threading the lubrication manipulation device onto an outer diameter of the shaft, wherein the lubrication manipulation device is configured to direct lubrication supplied to the outer diameter of the shaft radially away from the shaft; and
locking the lubrication manipulation device to the shaft with a locking element disposed proximate a threaded portion of the lubrication manipulation device, the locking lubrication manipulation device configured to interact with a threaded relationship between the threaded portion and a threaded region of the outer diameter of the shaft.

12. The method of claim 11, wherein the lubrication manipulation device comprises a relatively planar base oriented along an axial plane of the shaft.

13. The method of claim 12, wherein the lubrication manipulation device further comprises a torque element integrally formed with, and extending axially away from, the relatively planar base.

14. The method of claim 13, wherein the torque element comprises a plurality of surfaces to form a nut.

15. The method of claim 14, further comprising torqueing the lubrication manipulation device to the shaft by rotating the nut.

16. The method of claim 11, wherein the at least one component comprises at least one of a permanent magnet alternator, a clutch and a brake.
